(19) United States
(12) Patent Application Publication
(10) Pub. No.: US 2004/0106056 A1
(43) Pub. Date: Jun. 3, 2004

(54) Image forming toner and image forming method

(75) Inventors: Satoshi Takezawa, Ebina-shi (JP); Yasushige Nakamura, Ebina-shi (JP); Yoshimichi Katagiri, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/718,599

(22) Filed: Nov. 24, 2003

(30) Foreign Application Priority Data
Nov. 28, 2002 (JP) 2002-345715

(51) Int. Cl. G03G 13/20; G03G 9/08

(52) U.S. Cl. 430/108.4; 430/109.4; 430/124

(57) ABSTRACT

This invention relates to a toner for image formation that is used in developing an electrostatic latent image. In the toner of the present invention, an addition of a polyglycerol compound allows exhibiting an effect of dispersing a colorant in a water-repellent binding resin, thereby allows obtaining uniform dispersion by one-time kneading. Furthermore, since the degree of esterification of the polyglycerol compound is made 50% or higher and the degree of polycondensation n of polyglycerol is made from 9 to 30, even when the polyglycerol compound is added, the deterioration of electrostatic charging property and the filming can be prevented.

### CROSS-REFERENCE TO RELATED APPLICATION

This application claims priority under 35 USC 119 from Japanese patent Application No. 2002-345715, the disclosure of which is incorporated by reference herein.

### BACKGROUND OF THE INVENTION

1. Field of the Invention

This invention relates to image forming toner and image forming method for developing electrostatic latent image in electrophotographic copying machine, electrophotographic printer, and electrostatic recording machine. The invention relates particularly to image forming toner and image forming method that enable obtaining high image density and clear color reproduction, wherein pigments and the like are highly dispersed in the toner.

2. Description of the Related Art

Electrophotographic methods generally comprise providing uniform charge on photoconductive member such as photoreceptor drum, forming electrostatic image on the photoconductive member by imagewise irradiating the photoconductive member with radiation employing various methods, developing and visualizing the electrostatic latent image with fine particles called toner, transferring the image formed with the toner particles to a recording medium such as paper, and fixing the image formed with the toner particles. In this way, a printed matter is obtained. In the method, the toner is produced by mixing, melt-kneading, pulverizing, and classifying raw materials that comprise a binding resin, a dye/pigment, a charge controlling agent, a wax, and the like. The expression “dye/pigment” as used herein means dye, pigment, or both dye and pigment. It is important to disperse the dye/pigment and the charge controlling agent in the binding resin finely and uniformly. If these materials are not dispersed uniformly in the binding resin, the charging characteristics of the toner deterionate, toner particles having no charge or too much charge are generated, and toner fogging and toner scattering occur.

Further, if the dye/pigment is not dispersed finely, image quality including image density is lowered. It is necessary to disperse the dye/pigment well particularly in color toners in order to obtain clear tone and enlarge color reproduction range.

As methods for improving the dispersing quality of the dye/pigment in the toner, master batch method and flushing method are conventionally known.

As shown in FIG. 8, the masterbatch method comprises pre-kneading a binding resin for toner and a dye/pigment, adding the binding resin, a charge controlling agent, a wax, and the like to the pre-kneaded mixture, and kneading the mixture, wherein the proportion of the dye/pigment in the pre-kneading is higher than that in the final toner, and the dye/pigment is diluted by the addition of the binding resin, the charge controlling agent, the wax, and the like to the pre-kneaded mixture (See Japanese Patent Application Laid-Open (JP-A) Nos. 61-156054, 62-030259, 63-205664, and 5-011498).

As shown in FIG. 9, the flushing method comprises removing water from an aqueous slurry including a dye/pigment by a filter to convert the slurry to a wet-cake comprising 50-80% of water, kneading the wet-cake and a binding resin thereby dispersing the wet-cake in the binding resin to prepare a dispersion of the pigment/dye in the binding resin, adding the binding resin, a charge controlling agent, and a wax to the dispersion, and kneading, pulverizing, and classifying the mixture to produce the toner (See JP-A Nos. 4-242752, 6-250444, 6-130724, and 9-026673).

However, by the conventional masterbatch method, since the kneading is carried out twice, the operation efficiency is decreased and the cost is elevated. Further, factors such as the molecular weight of the resin deviate from the design values for reasons such as the reason that the kneading carried out twice degrades the resin and breaks chains in the polymer resin to decrease the molecular weight of the resin. The decrease in the molecular weight of the binding resin decreases the viscosity of the toner and make the toner binding resin volatile, thereby causes problems such as fixing trouble.

Also by the flushing method, since the kneading is carried out twice, problems similar to the problems in the case of the masterbatch method arise. Further, since a dye/pigment dispersed in water is used, the water may remain in the toner and may affect the charging property of the toner though most of the water is removed from the system.

Demand for high-resolution image in recent years requires finer toner. For producing fine toner, a technique for producing toner with higher dispersing quality of dye/pigment by employing easy methods without burdensome processes such as the kneading carried out twice, is required. Finer toner is strongly demanded particularly in the field of color toner since the dispersing quality of color toner strongly affect the color reproducibility.

### SUMMARY OF THE INVENTION

An object of the present invention is to provide an image forming toner in which a dye/pigment and the like are dispersed in a binding resin with high dispersing quality, and an image forming method that provides such toner in a relatively easy manner.

Another object of the invention is to provide an image forming toner and an image forming method which prevent defective charging caused by inferior dispersing of a dye/pigment in a binding resin, decrease in image density, and contraction of color reproducing range.

Still another object of the invention is to provide an image forming toner and an image forming method with charging property which is high and stable even in continuous printing or under high temperature and high humidity.

In order to achieve such objects, the image forming toner according to the invention comprises at least a binding resin, a colorant (dye/pigment), and a polyglycerol ester compound. It is preferable that the image forming toner should further include a charge controlling agent. A single kind of or plural kinds of these respective substances may be used in the present invention. The polyglycerol ester compound is a compound having a chemical structure represented by the structural formula (1).

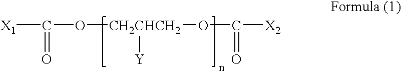

In the formula (1), X₁ and X₂ each independently represent an aliphatic hydrocarbon having 9-39 carbon atoms; Y represents OH or OCOX₁; n, which is degree of polycondensation, is an integer from 9 to 30.

As a result of the investigation of the present inventors, it has been found that addition of the polyglycerol ester compound improves the dispersing quality of a colorant, a charge controlling agent or the like in a toner, improves the electrostatic charging property, and expand the color reproduction range.

As a reason for this, it is assumed that since the polyglycerol ester compound has a non-polar aliphatic group and a polar group such as an ester group or a —OH group, the polyglycerol ester compound activates surface. That is, in general, since a binding resin is water-repellent and a colorant is hydrophilic, the polyglycerol ester compound works as a surfactant, resulting in an improvement in the dispersibility of the colorant into the binding resin.

Furthermore, it is also considered that since the polyglycerol ester compound is a wax-like low-melting point compound, when the polyglycerol ester compound is exposed to high temperature in, for example, a kneading process in a preparation of a toner, the polyglycerol ester compound fuses and a viscosity thereof decreases, resulting in excellent wetting on solid matters such as the colorant and charge controlling agent and improvement in the dispersing quality.

Still furthermore, the inventors, after investigation, have found that even when the polyglycerol ester compound is used in toner, if the esterification rate of the polyglycerol ester compound is less than 50%, the electrostatic charging property of the toner is deterionated. Thus, it is considered that a remaining unesterified hydrophilic —OH group contributes to an anti-charge effect. As polyglycerol, polyglycerols in which more than half of the hydrophilic —OH groups is esterified, that is, polyglycerols having the esterification ratio of 50% or more can excellently maintain the electrostatic charging property.

Furthermore, after the investigation regarding polycondensation degree n of polyglycerol, the inventors have found that when the degree of polycondensation n is small, toner having small molecular weight component becomes soft; accordingly, when the toner is agitated, the blocking in which the toner particles are combined with each other, a filming phenomenon of the toner to a development roller, and a filming phenomenon of the toner to a photoreceptor drum owing to the development stress are caused. Accordingly, the degree of polycondensation n is preferably from 9 to 30 in order to prevent the filming.

Still furthermore, since the polyglycerol ester compound is white colored or light-colored, when it is used in a color toner, it can contribute to an improvement in the color reproducibility of the color toner without lowering the degree of chroma thereof. In addition, the polyglycerol ester compound, being a wax-like compound, can be widely applied to fixation systems, including heat roller fixation, pressure fixation, solvent fixation, and photo-fixation.

### BRIEF DESCRIPTION OF THE DRAWINGS

FIG. 1 is an explanatory diagram of a toner preparation procedure according to one embodiment of the present invention.

FIG. 2 is an explanatory formula of a polyglycerol ester compound that is used in the invention.

FIG. 3 is a schematic view showing a tandem type printer that is used in Examples 1, 2 and 3 of the invention.

FIG. 4 is a graph showing the relation between the esterification ratio of polyglycerol and electrification quantity of toner according to the invention.

FIG. 5 is a table showing the relation between the degree of polycondensation of polyglycerol and the number of added esters for explaining the difference between the polyglycerol ester compound according to the invention and a polyglycerol ester compound according to a known technology.

FIG. 6 is a schematic view showing a flash fixation type printer that is used in Example 4 of the invention.

FIG. 7 is an explanatory table of fixability investigation in Example 4 and Comparative example 2 of the invention.

FIG. 8 is an explanatory diagram of a toner preparation procedure according to a first conventional technology.

FIG. 9 is an explanatory diagram of a toner preparation procedure according to a second conventional technology.

### DETAILED DESCRIPTION OF THE INVENTION

The binder resin that is used in the toner according to the invention is not particularly limited, and thermoplastic resins made of various kinds of natural or synthetic polymers can be used. Typically, the binder resin is a resin having a weight average molecular weight of from approximately 5,000 to 100,000, and may be epoxy resins, styrene-acrylic resins, polyamide resins, polyester resins, polyvinyl resins, polyurethane resins, polybutadiene resins all of which have a melting point of from 90 to 140° C., or the like. Single kind of binder resin or multiple kinds of binder resins can be used.

The polyglycerol ester compounds that are used in the invention denote ester compounds between polyglycerols, which are obtained by dehydration condensation of glycerins, and organic compounds such as fatty acids and aromatic acids. The polycondensation degree n of each of the polyglycerols is preferably from 9 to 30 since the molecular weight of the polyglycerol ester compound becomes large, the polyglycerol ester compound exhibits sufficient dispersing action, and the filming phenomenon can be prevented. As the organic compounds, in general, fatty acids having 9 to 39 carbon atoms can be used.

In addition, because the polyglycerol ester compound according to the invention has the esterification ratio of 50% or more, the polyglycerol ester compound suppresses decrease in the electrostatic charging property while performing dispersing function. The polyglycerol ester compound is added to a toner in the range of from 0.1 to 10% by weight based on the whole toner. When it is added more than 10% by weight, since the toner itself becomes soft, the filming tends to occur; on the other hand, when it is added less than 0.1% by weight, desired dispersing function cannot be exhibited. The polyglycerol ester compound is added to a toner most preferably in the range of from 1 to 5% by weight.

The colorant used in the invention is also not particularly restricted, and may be any dye, pigment, or the like. For example, for color toners, quinacridone (red), phthalocyanine (blue or the like), anthraquinone (red), disazo (red or yellow), monoazo (red), anilide base compounds (yellow), benzidine (yellow), benzimidazolone (yellow), halogenated phthalocyanine (green) or the like can be used. For black toners, black pigments such as carbon black, nigrosin dye, ferrite, magnetite, titanium black can be used.

An addition amount of the colorant, though depending on the kind thereof, is generally in the range of from 0.01 to 50% by weight, and more preferably from 0.1 to 20% by weight.

The charge controlling agent that is used in the invention is used for controlling the electrostatic charging property of the toner. There is no particular restriction as far as it can cause the toner to be charged. In particular, in the color toner, colorless and light-colored charge controlling agents are preferable in consideration of a small influence on the hue of the toner. Preferably, as positive polarity charge controlling agent, quaternary ammonium salts (colorless), nigroshin dyes (black), triphenyl methane derivatives (blue) or the like can be used, and as negative polarity charge controlling agent, naphtholic acid-zinc complex (colorless), salicylic acid-zinc complex (colorless), boron compounds or the like can be used. An amount of the charge controlling agent to be added, though depending on the kind thereof, is generally in the range of from approximately 0.1 to 10% by weight.

In the invention, in order to improve the fixability of the toner, wax or the like can be further added. As the wax compositions, natural waxes, synthetic waxes or the like can be widely used. For example, as petroleum base wax, paraffin wax, microcrystalline wax or the like; as mineral wax, Fisher-Tropsh wax, montan wax or the like; as plant wax, carnauba wax or the like; as animal wax, bees wax, lanolin or the like; as synthetic wax, polyolefins such as polyethylene, polypropylene, fatty acid esters, amide base waxes, modified polyolefins or the like; and as other compound, terpene base compounds, polycaprolactones or the like can be widely used singly or in combination. Among these, waxes that have softening temperatures of 150° C. or less are preferable, and waxes that have a softening temperatures lower than a fuse-softening temperature of a toner binder resin are particularly preferable.

In the invention, an additive that is added to the toner can be used, and as the additive, materials that are usually used can be widely applied. That is, inorganic fine particles such as silica, titania, alumina, zinc oxide, products obtained by subjecting the inorganic particles to hydrophobicity imparting treatment, or resin particles of polystyrene, PMMA, melamine resin or the like can be applied.

In the case where the toner according to the invention is applied to the flash fixing system, a light absorbing material having a principal absorption wavelength region in a principal emission wavelength region of a flash lamp, a light absorbing material having an absorption wavelength peak on a longer wavelength side than the principal emission wavelength region, or a light absorbing material having a substantially flat light absorptivity over at least from a principal emission wavelength region to a visible light region, can be added. For example, aluminum salts, indium-oxide-type metal oxides, tin-oxide-type metal oxides, zinc-oxide-type metal oxides, cadmium stannate, specific amide compounds, naphthallocyanine and/or phthalocyanine-type compounds, cyanine compounds, lanthanide compounds, infrared absorbing materials such as nickel complexes, or black pigments such as carbon black, titanium black, ferrite, magnetite, zirconium carbide or the like can be used. These can be used singly or in combination.

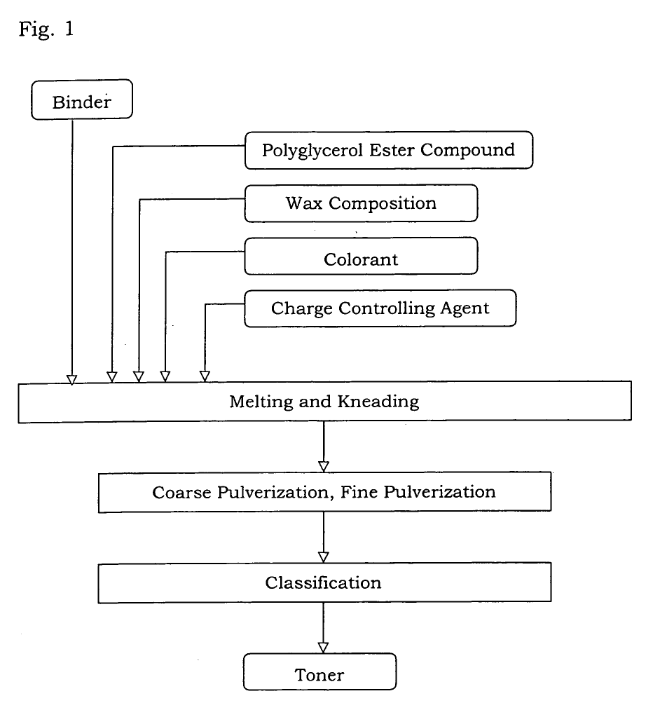

As a preferable toner preparation procedure according to the invention, a method similar to an ordinary toner preparation method can be used. As shown in FIG. 1, in the case where the toner is prepared according to a pulverization method, after toner ingredients such as a binder resin, a polyglycerol ester compound, a colorant, a charge controlling agent, and optionally a wax composition are mixed, the above materials are melted and kneaded by use of a kneader or extruder. Thereafter, the molten and kneaded material is coarsely pulverized, then finely pulverized by use of a jet mill or the like, then classified by use of an air classifier to obtain toner particles having a target particle size. Further, an additive is added, and a complete toner is obtained.

And an embodiment of the invention is an image forming toner (T) comprising at least a binding resin, a colorant, and a polyglycerol ester compound represented by the following formula (1), wherein an esterification ratio of the polyglycerol ester compound is 50% or higher and a polycondensation degree n of the polyglycerol is an integer from 9 to 30:

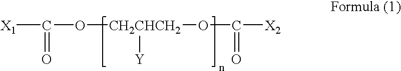

wherein in formula (1), X₁ and X₂ each independently represent an aliphatic hydrocarbon having 9-39 carbon atoms; and Y represents OH or OCOX₁.

Another embodiment of the invention is the image forming toner (T), further comprising a charge controlling agent.

Another embodiment of the invention is the image forming toner (T), wherein the polyglycerol ester compound is contained in the toner in an amount of 0.1 to 10% by weight.

Another embodiment of the invention is the image forming toner (T), wherein the polyglycerol ester compound is contained in the toner in an amount of 1 to 5% by weight.

Another embodiment of the invention is the image forming toner (T), wherein the image forming toner is a one-component development toner.

Another embodiment of the invention is the image forming toner (T), wherein the image forming toner is a two-component development toner that is used in combination with a carrier.

Another embodiment of the invention is the image forming toner (T), wherein the binding resin is a polyester resin.

Another embodiment of the invention is the image forming toner (T), wherein the colorant is a color colorant.

Another embodiment of the invention is the image forming toner (T), wherein the toner is used in flash fixation and further includes at least one light absorbing material selected from the group consisting of a light absorbing material having a principal absorption wavelength region in a principal emission wavelength region of a flash lamp, a light absorbing material having an absorption wavelength peak at a wavelength that is longer than said principal emission wavelength region, or a light absorbing material having substantially flat light absorptivity at least from said principal emission wavelength region to a visible light region.

Another embodiment of the invention is the image forming toner (T), wherein the esterification rate of the polyglycerol ester compound is obtained by ¹H-NMR measurement.

Another embodiment of the invention is an image forming method (W) comprising the steps of: developing an electrostatic latent image on an image bearing body by use of an image forming toner that includes at least a binding resin, a colorant, and a polyglycerol ester compound represented by the formula (1); transferring the developed toner image onto a recording medium; and fixing the toner image on the recording medium, wherein an esterification ratio of the polyglycerol ester compound is 50% or higher, and a polycondensation degree of n of the polyglycerol is an integer from 9 to 30.

Another embodiment of the invention is the image forming method (W), wherein the image forming toner further comprises a charge controlling agent.

Another embodiment of the invention is the image forming method (W), wherein the polyglycerol ester compound is contained in the image forming toner in an amount of 0.1 to 10% by weight.

Another embodiment of the invention is the image forming method (W), wherein the polyglycerol ester compound is contained in the image forming toner in an amount of 1 to 5% by weight.

Another embodiment of the invention is the image forming method (W), wherein the developing step includes one-component development using the image forming toner.

Another embodiment of the invention is the image forming method (W), wherein the developing step includes two-component development in which the image forming toner is used in combination with a carrier.

Another embodiment of the invention is the image forming method (W), wherein the binding resin of the image forming toner is a polyester resin.

Another embodiment of the invention is the image forming method (W), wherein the colorant of the image forming toner is a color colorant.

Another embodiment of the invention is the image forming method (W), wherein the fixing step includes flash fixation of the image forming toner which further includes at least one light absorbing material selected from the group consisting of a light absorbing material having a principal absorption wavelength region in a principal emission wavelength region of a flash lamp, a light absorbing material having an absorption wavelength peak at a wavelength that is longer than said principal emission wavelength region, or a light absorbing material having substantially flat light absorptivity at least from said principal emission wavelength region to a visible light region.

Another embodiment of the invention is the image forming method (W), wherein the esterification ratio of the polyglycerol ester compound of the image forming toner is obtained by ¹H-NMR measurement.

### EXAMPLES

### Examples according to the present invention will be shown below. However, the invention is not restricted to the following Examples.

### Example 1

As a binder resin, a sulfonic acid modified polyester resin that included terephthalic acid, ethylene oxide adduct of bis-phenol A, and bis(4-hydroxyphenyl)sulfonic acid as indispensable constituent monomers, and had an acid value of 30 mg/KOH and a softening temperature of 104° C. was used. To this binder resin, as the colorant, 7% by weight of carbon black (MOGUL L manufactured by Cabot Corp.); as the charge controlling agent, 3% by weight of calixarene compound (trade name: E-89, manufactured by Orient Chemical Industries, Ltd.); and 2% by weight of polyglycerol ester (in the above chemical formula (1), n=10, the degree of esterification: 67%, X₁, X₂=aliphatic hydrocarbons with 22 carbon atoms) were added, and the mixture was melted and kneaded, then pulverized and classified. In this way, a toner matrix having an average particle size of 8 μm was obtained. When an ultra-thin section of the toner was prepared and observed with TEM (transmission electron microscope), the dispersing quality of the pigment (carbon black) was excellent.

In the calculation of the esterification ratio, ¹H-NMR was used. As is generally known, the NMR (Nuclear Magnetic Resonance Spectrometer) measures a frequency and an absorption intensity of an electromagnetic wave that an atomic nucleus (¹H) absorbs when a compound in a magnetic field is irradiated with an electromagnetic wave. The absorption frequency shows a binding state of the atomic nucleus.

For example, information such as “atom (H) binds to a carbon atom (C) which binds to an oxygen atom (0)” or “atom (H) is a H of a methylene group (CH₂) that binds to a carbonyl group (CO)” can be obtained. Furthermore, from the intensity of the absorption, an amount of H atoms can be determined.

In this example, ¹H-NMR measurement was performed of a chloroform solution (concentration 2%) of polyglycerol ester with FT-NMR (trade name: FX-200, manufactured by JEOL. Ltd.), and a peak integral value (a) derived from methenyl groups and methylene groups of a glycerin skeleton, which is a main chain of polyglycerol ester, and a peak integration value (b) of methylene groups bonded to a side chain ester group were compared.

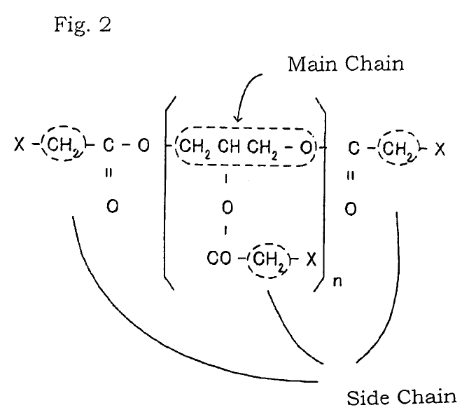

Now, in the polyglycerol ester compound represented by the chemical formula in FIG. 2, when the polycondensation degree n is 10 and the esterification ratio is 100%, the number of hydrogen atoms in a main chain (CH2CHCH20), which is the number of hydrogen atoms linked to carbon atoms which is bonded to an oxygen atom, is 5×n=50, and the number of hydrogen atoms contained in methylene groups (CH2) which is bonded to a carbonyl group (CO) on a side chain is (2+n)×2=24.

A ratio (a, b) of the respective amounts of hydrogen atoms is obtained by NMR and compared with a theoretical ratio (amount of hydrogen atoms on the main chain: amount of hydrogen atoms on the side chain=50:24) in the case of the esterification ratio of 100%, whereby the esterification ratio can be calculated. That is, the following equation is satisfied: 50 (the number of hydrogen atoms on the main chain): 24 (the number of hydrogen atoms on the side chain)×(esterification ratio/100)=a: b. Accordingly, from the following equation, the esterification ratio can be obtained:

Esterification ratio=50/24×b/a×100 (%)

This is a case where n=10 in the above chemical formula (1).

To this toner matrix, as the additive, 0.35 parts by weight of hydrophobic silica (trade name: H-2000, manufactured by Clariant (Japan) K.K.) and 0.3 parts by weight of RX-50 (trade name, manufactured by Nippon Aerosil Co., Ltd.) were added, thereby a toner (A-1) was obtained.

The toner was mixed with silicone-coated ferrite carrier having a particle size of 60 μm at a toner concentration of 4.5%, whereby a two-component development agent was constituted. An amount of electricity thereof was measured by use of a blow-off charge amount measuring device (manufactured by Toshiba Chemical Corp.) and found to be −20 μC/g.

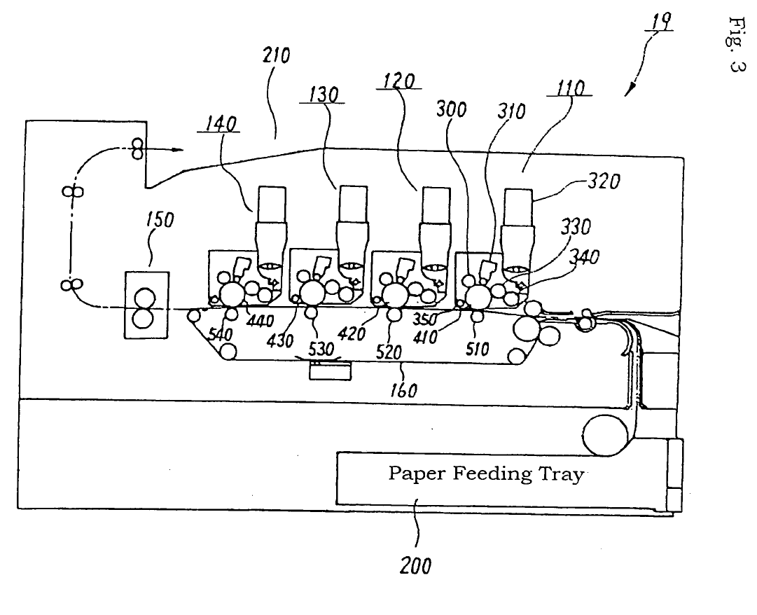

Furthermore, the toner (A-1) was put in a tandem type color printer (GL8300A remodeled device, manufactured by Fujitu Co., Ltd.) 19 that adopted non-magnetic one component development/heat roller fixation shown in FIG. 3, a development bias or the like were adjusted so that the amount of the toner on paper became 6 g/m², and development and fixing were performed.

When a plane image of 1-inch square was measured for image density by a colorimeter (X-Rite Incorporated.), an excellent value of 1.35 was obtained (wherein an image density of 1.3 or more was judged as excellent). In the image, there were no defects such as offset.

In the tandem printer 19 shown in FIG. 3, a sheet in a sheet cassette 200 was allowed to pass through four electrophotographic engines 110, 120, 130 and 140 by means of a transport belt 160 to form a four color toner image followed by fixing by a heat roller fixing device 150 further followed by outputting to a stacker 210. The respective electrophotographic engines 110, 120, 130 and 140 were disposed sequentially along a sheet transport path, and each of the electrophotographic engines included a fore-charger 300, an exposer 310, photoreceptor drums 410, 420, 430 and 440, developing machines 330 and 340, transfer rollers 510, 520, 530 and 540 and a cleaner 350. To the respective developing machines 330 and 340, from a toner hopper 320, nonmagnetic one-component toners of the respective colors (Y, M, C, and K) were supplied.

### Example 2

As a binder resin, a sulfonic acid modified polyester resin that included terephthalic acid, ethylene oxide adduct of bis-phenol A, and bis(4-hydroxyphenyl)sulfonic acid as indispensable constituent monomers, and had an acid value of 30 mg/KOH and a softening temperature of 104° C. was used. To this, as the colorant, 4% by weight of blue pigment (trade name: B2G, manufactured by Clariant (Japan) K.K.); as the charge controlling agent, 3% by weight of calixarene compound (trade name: E-89, manufactured by Orient Chemical Industries, Ltd.); and 2% by weight of polyglycerol ester compound (represented by the above chemical formula (1), wherein n=10, the degree of esterification: 83%, X₁, X₂=aliphatic hydrocarbons with 22 carbon atoms) were added, and the mixture was melted and kneaded, then pulverized and classified. In this way, a toner matrix having an average particle size of 8 μm was obtained. As a result of the above-mentioned TEM observation, the dispersing quality of the pigment (blue pigment) was found to be excellent.

To this toner matrix, as the additive, 0.35 parts by weight of hydrophobic silica (trade name: H-2000, manufactured by Clariant (Japan) K.K.) and 0.3 parts by weight of RX-50 (trade name, manufactured by Nippon Aerosil Co., Ltd.) were added, whereby a toner (B-1) was obtained. The degree of esterification was measured according to the method employed in Example 1.

The amount of electricity of the toner (B-1) was measured according to a method similar to that in Example 1 and found to be −22 μC/g, which was substantially the same value as that of the toner (A-1) in Example 1.

Furthermore, printing test was performed under the same conditions by use of a printer similar to that in Example 1, the image density was measured with the above-mentioned calorimeter, and an excellent value of 1.31 was obtained. In the image, there were found no defects such as offset.

### Example 3

Example 3 is an example in a case where a polyglycerol ester compound is blended with other wax is shown. In Example 1, in order to attain a wax function, 2% by weight of the polyglycerol ester compound was added. However, in Example 3, to the binder resin, the colorant, and the charge controlling agent that were used in Example 1, 1% by weight of the polyglycerol ester compound used in Example 1, and as other waxes, two kinds of 1% by weight of a pentaerythritol tetrabehenyl ester compound and 1% by weight of polypropylene (molecular weight 10000, softening temperature 150° C.) were added. Then, according to the procedure similar to that in Example 1, a toner (A-2) of Example 3 was prepared.

The amount of electricity of the toner (A-2) was measured according to the measurement method similar to that in Example 1 and found to be −20 μC/g, which was substantially the same value as that in the toner (A-1) in Example 1. The printing test was performed with a printer similar to that in Example 1 and the image density was measured in the similar manner as that in Example 1 and found to be an excellent value of 1.35. In the image, there were found no defects such as offset.

### Comparative example 1

A Comparative example 1 where a polyglycerol ester compound having the esterification ratio of less than 50% was added was prepared. To the binder resin, the colorant, and the charge controlling agent that were used in Example 1, 2% by weight of the polyglycerol ester compound (represented by the chemical formula (1), wherein n=3 to 9 with the average of 5, the esterification ratio 46% and X₁, X₂=aliphatic hydrocarbon with 22 carbon atoms) was added, and according to the similar procedure as Example 1, a toner of comparative example (A-3) was prepared.

The amount of electricity of the toner was measured according to the measurement method similar to that in Example 1 and found to be −15 μC/g. The toner (A-3) of comparative example is lower in the charge in comparison with that of the toner (A-1) in Example 1. When the developing agent was agitated for 3 hr, a charge amount decreases to −8 μC/g. As a reason for this, it is considered that the addition of the polyglycerol ester compound low in the esterification ratio caused charge failure.

The printing test was carried out with a printer similar to that in Example 1 under the same condition. As a result, an image poor in the transferability and strong in the graininess was obtained. This is inferred that owing to the charge failure the transferability was deteriorated. There were found no occurrences of offset or the like.

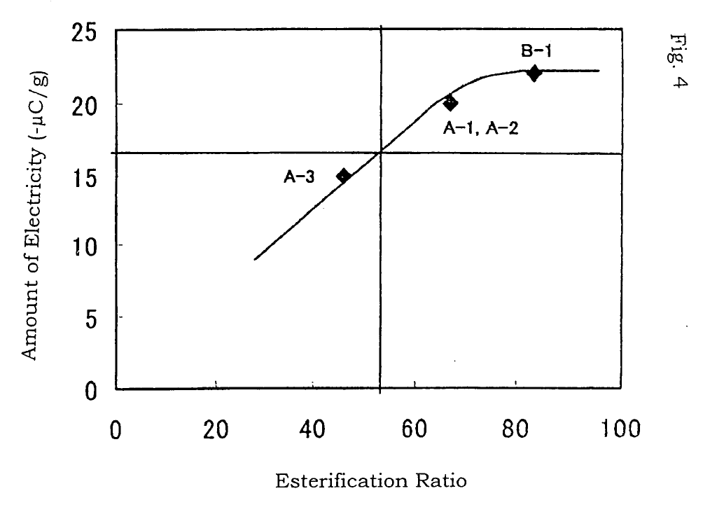

The results of Examples 1, 2 and 3 and Comparative example 1 are plotted with the esterification ratio (%) of polyglycerol ester added to the toner as a horizontal axis and the amount of electricity (−μC/g) of the toner as a vertical axis and are shown in FIG. 4. As shown in FIG. 4, there is correlation between the esterification ratio and the charge amount of the toner, and when the esterification ratio becomes lower, the amount of electricity tends to decrease.

The reason for this tendency is considered that unesterified hydrophilic —OH groups remaining in polyglycerol ester inhibit the charging of the toner. It was shown that in the Examples, in order to obtain the amount of electricity of −17 μC/g or more that gives an excellent image, polyglycerol esters having the esterification ratio of 50% or higher can be preferably used.

Thereby, it was shown that, in order to obtain excellent toner characteristics, polyglycerol in which more than half of the —OH groups are esterified, that is, the esterification ratio is more than 50%, is adequate for the polyglycerol compound that is added to the toner.

In Japanese Patent Application Laid-Open (JP-A) No. 4-184350, though different in the object from the present invention, a toner in which from 1 to 40% by weight of a partially esterified polyglycerol compound is blended is disclosed. According to the technology disclosed in JP-A No. 4-184350, in order to reduce the melt viscosity of a toner to improve the fluidity at low temperatures, the partially esterified polyglycerol compound small in the degree of polycondensation n of polyglycerol (n=2 to 10) is added.

In the technology disclosed in JP-A No. 4-184350, it is recited that examples of the partially esterified compounds between these polyglycerols and fatty acids having 10 to 40 carbon atoms, (omitted), include polyglycerol monobehenate, polyglycerol dibehenate, polyglycerol tribehenate, polyglycerol tetrabehenate, polyglycerol pentabehenate or the like, and materials disclosed as examples are polyglycerol tribehenate and polyglycerol tetrabehenate.

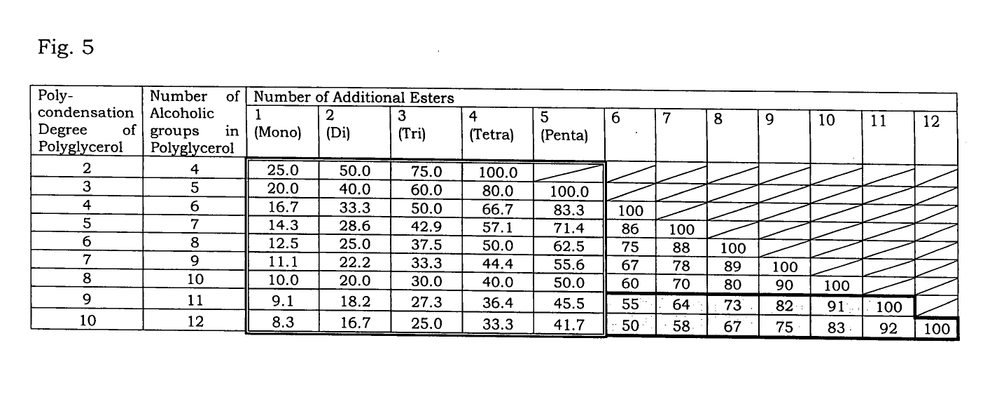

Regarding polyglycerol compounds according to the disclosed technology and the present invention, the degree of polycondensation (n) of polyglycerol, which is the number of alcohols in polyglycerol, the number of added esters, and the esterification ratio are calculated, and the results are shown in FIG. 5. Even in the polyglycerol ester compounds according to the disclosed technology (within broad double line in FIG. 5) included a polyglycerol ester compound having n of 3 or more and the esterification ratio of 50% or higher. However, as verified in Comparative example 1 (esterification ratio 46%, n=3 to 9 with the average of 5), when n is less than 9, since not only the amount of electricity of toner is low but also the molecular weight is small, the toner itself becomes soft and the filming is caused. From the object of the disclosed technology in that the melt viscosity of the toner is lowered to improve the fluidity at low temperatures, a scope of the disclosed technology aims at reducing the melt viscosity and thereby softening the toner itself by addition of a polyglycerol ester compound while ignoring the filming.

In the invention, the polyglycerol ester compound is added for obtaining high dispersing quality of the colorant and the charge controlling agent, for preventing the decrease in the amount of electricity, and for preventing the filming. It is verified that, in order to achieve the object of the invention, a range where the esterification ratio is 50% or more and the degree of polycondensation n is large, that is, n=9 to 30 is optimum, wherein the range includes the portion surrounded by a single broad line and hatched in FIG. 5.

### Example 4

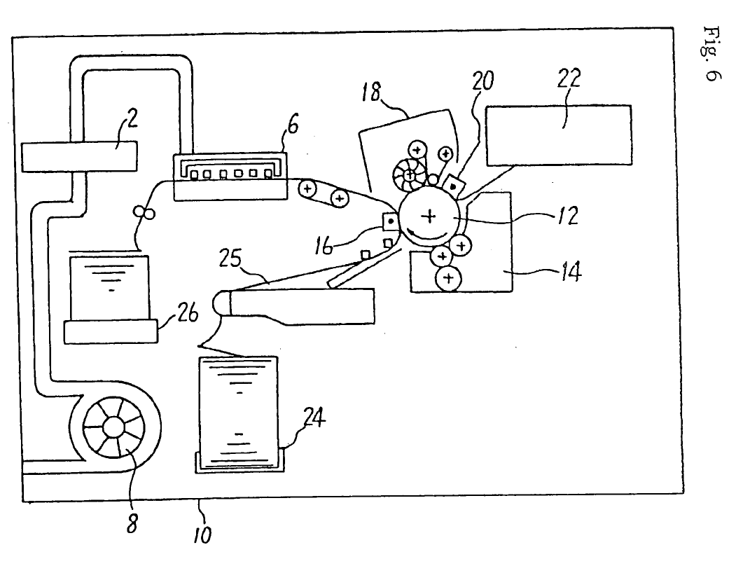

The toner (A-1) according to Example 1 was blended with silicone coat ferrite carrier having a particle size of 60 μm at a toner concentration of 4.5%, whereby a two-component developing agent was prepared. The developing agent was put in an evaluation machine obtained by remodeling a continuous paper printer (product No. PS2160, manufactured by Fujitu Ltd.) that adopts a flash fixing system shown in FIG. 6 so that a flash applying voltage can be varied, and the fixability is investigated as follows.

First, with a development bias and a surface potential of a photoreceptor adjusted so that a toner development amount became 5 to 6 g/m², a solid image of 1-inch square was developed. Subsequently, the developed image was irradiated with xenon flash lamp light having a high emission intensity in the wavelength range of from 800 to 1500 nm to be fixed on a standard paper (trade name: NIP-1500LT, manufactured by Kobayashi Kirokushi Co., Ltd.), whereby a printed image is obtained. At this time, an input voltage to the flash lamp was varied from 1850 to 1350 V, and fixed images at the respective applying voltages were prepared.

Then, the above 1-inch square printed image was measured for the optical density (OD1) by the above-mentioned calorimeter, thereafter an adhesive tape (trade name: SCOTCH MENDING TAPE, manufactured by Sumitomo 3M Co., Ltd.) was stuck on the printed image followed by peeling of the tape, thereafter the optical density (OD2) of the printed image after the peeling was measured by the calorimeter. The fixation rate was calculated according to the following equation (2).

Fixation rate (%)=OD2/OD1×100 (2)

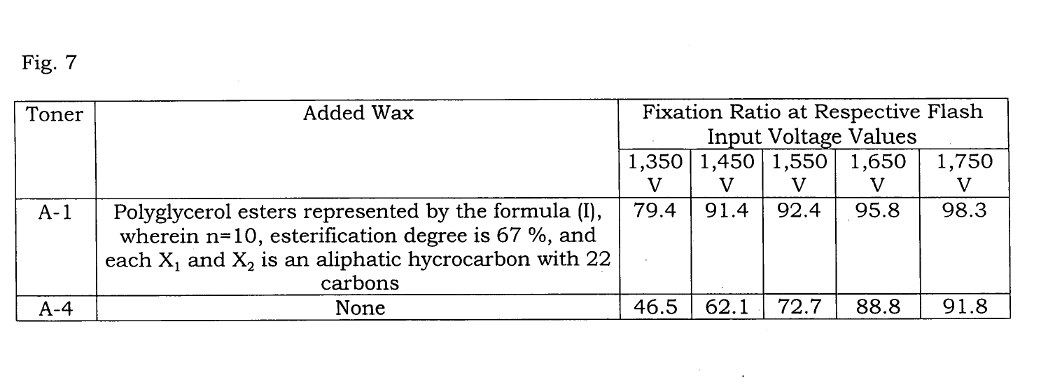

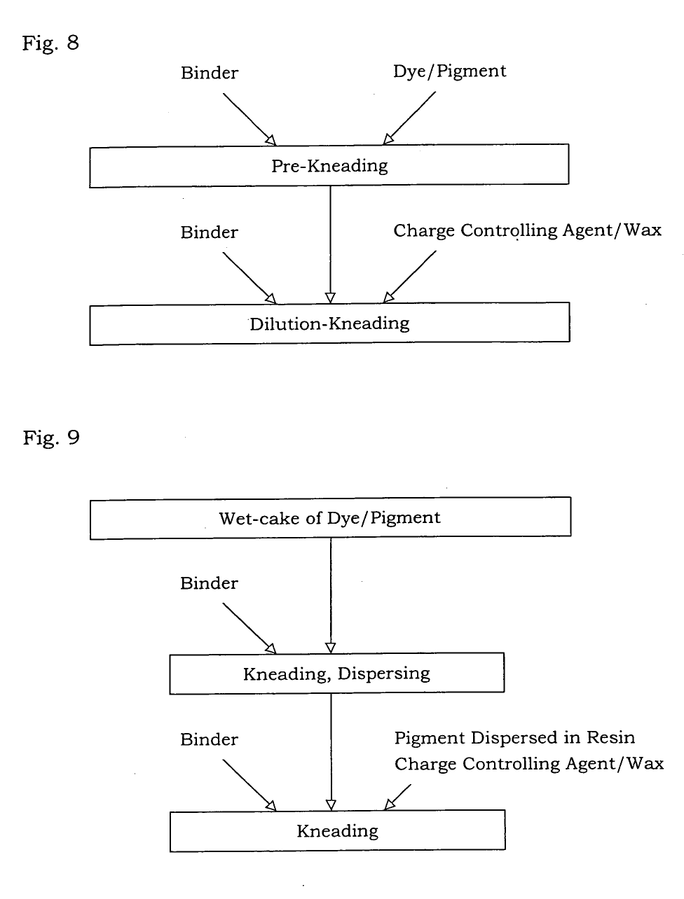

The results of the fixability test aree shown in FIG. 7. At the flash applying voltages of 1550 V or higher, excellent printed images having the density of 1.3 or more could be obtained. Moreover, at the flash applying voltages of 1550 V or higher, excellent images having little background contamination such as fogging could be obtained.

In the continuous paper printer shown in FIG. 6, a photoreceptor drum 12 is charged by the fore-charger 20 followed by exposure by an exposer 22. Thereafter, an electrostatic latent image on the photoreceptor drum 12 is toner-developed with a two-component developer 14 and transferred to continuous paper 25 by a transfer device 16. The toner image on the continuous paper 25 is fixed by flashlight from a flash fixing device 6. The continuous paper 25 is transported from a hopper 24 through the transfer device 16 and the flash fixing device 6 to the stacker 26. A sublimate of the toner owing to the flash fixation at the flash fixing device 6 is recovered by a filter 2 and exhausted outside of the system by a blower.

### Comparative example 2

A comparative example wherein the polyglycerol ester compound was not added was prepared. That is, a toner (A-4) was prepared according to Example 1 except that the polyglycerol ester compound was not added.

The toner was subjected to the printing test by a printer similar to that in Example 4 under the same condition. In Comparative example 2, in order to obtain the density of 1.3, a flash applying voltage of 1750 V or more was required. In comparison with the toner (A-1) according to Examples 1 and 4, it can be said that it is more difficult to obtain a higher image density with the toner (A-4).

An ultra-thin section of the toner according to Comparative example 2 was prepared and observed with the TEM. It was confirmed that the dispersing quality of carbon was lowered in comparison with the toner according to Example 4. The experimental results of the fixation rate itself are shown together in FIG. 7. From the comparison with Example 4, an improvement in the fixability owing to the addition of polyglycerol ester was also confirmed.

According to the above result, not only in the heat roll fixation but also in the flash fixation, it was confirmed that the toner according to Examples 1 and 4 exhibited the dispersing effect and the fixation effect owing to the addition of the polyglycerol compound.

As described above, according to the invention, the addition of a polyglycerol compound allows a water-repellent binding resin to exhibit an effect of dispersing a colorant and a charge controlling agent; accordingly, one-time kneading provides a uniform dispersion. Furthermore, since the esterification ratio of the polyglycerol compound is made 50% or more and the polycondensation degree n of polyglycerol is made 9 to 30, even when the polyglycerol compound is added, the deterioration of electrostatic charging property and the filming can be prevented.

What is claimed is:

1. An image forming toner comprising at least a binding resin, a colorant, and a polyglycerol ester compound represented by the following formula (1), wherein an esterification ratio of the polyglycerol ester compound is 50% or higher and a polycondensation degree n of the polyglycerol is an integer from 9 to 30: 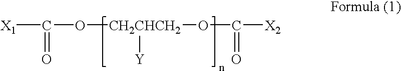
wherein in formula (1), X₁ and X₂ each independently represent an aliphatic hydrocarbon having 9-39 carbon atoms; and Y represents OH or OCOX₁.

2. An image forming toner according to claim 1, further comprising a charge controlling agent.

3. An image forming toner according to claim 1, wherein the polyglycerol ester compound is contained in the toner in an amount of 0.1 to 10% by weight.

4. An image forming toner according to claim 3, wherein the polyglycerol ester compound is contained in the toner in an amount of 1 to 5% by weight.

5. An image forming toner according to claim 1, wherein the image forming toner is a one-component development toner.

6. An image forming toner according to claim 1, wherein the image forming toner is a two-component development toner that is used in combination with a carrier.

7. An image forming toner according to claim 1, wherein the binding resin is a polyester resin.

8. An image forming toner according to claim 1, wherein the colorant is a color colorant.

9. An image forming toner according to claim 1, wherein the toner is used in flash fixation and further includes at least one light absorbing material selected from the group consisting of a light absorbing material having a principal absorption wavelength region in a principal emission wavelength region of a flash lamp, a light absorbing material having an absorption wavelength peak at a wavelength that is longer than said principal emission wavelength region, or a light absorbing material having substantially flat light absorptivity at least from said principal emission wavelength region to a visible light region.

10. An image forming toner according to claim 1, wherein the esterification rate of the polyglycerol ester compound is obtained by ¹H-NMR measurement.

11. An image forming method comprising the steps of: developing an electrostatic latent image on an image bearing body by use of an image forming toner that includes at least a binding resin, a colorant, and a polyglycerol ester compound represented by the following formula (1); transferring the developed toner image onto a recording medium; and fixing the toner image on the recording medium, wherein an esterification ratio of the polyglycerol ester compound is 50% or higher, and a polycondensation degree of n of the polyglycerol is an integer from 9 to 30: 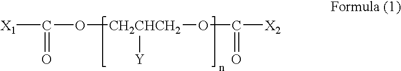
wherein in formula (1), X₁ and X₂ each independently represent an aliphatic hydrocarbon having 9-39 carbon atoms; and Y represents OH or OCOX₁.

12. An image forming method according to claim 11, wherein the image forming toner further comprises a charge controlling agent.

13. An image forming method according to claim 11, wherein the polyglycerol ester compound is contained in the image forming toner in an amount of 0.1 to 10% by weight.

14. An image forming method according to claim 13, wherein the polyglycerol ester compound is contained in the image forming toner in an amount of 1 to 5% by weight.

15. An image forming method according to claim 11, wherein the developing step includes one-component development using the image forming toner.

16. An image forming method according to claim 11, wherein the developing step includes two-component development in which the image forming toner is used in combination with a carrier.

17. An image forming method according to claim 11, wherein the binding resin of the image forming toner is a polyester resin.

18. An image forming method according to claim 11, wherein the colorant of the image forming toner is a color colorant.

19. An image forming method according to claim 11, wherein the fixing step includes flash fixation of the image forming toner which further includes at least one light absorbing material selected from the group consisting of a light absorbing material having a principal absorption wavelength region in a principal emission wavelength region of a flash lamp, a light absorbing material having an absorption wavelength peak at a wavelength that is longer than said principal emission wavelength region, or a light absorbing material having substantially flat light absorptivity at least from said principal emission wavelength region to a visible light region.

20. An image forming method according to claim 11, wherein the esterification ratio of the polyglycerol ester compound of the image forming toner is obtained by ¹H-NMR measurement.
